(19) United States
(12) Patent Application Publication
(10) Pub. No.: US 2010/0324700 A1
(43) Pub. Date: Dec. 23, 2010

(54) FACILITIES CONTROL DEVICE AND FACILITIES CONTROL METHOD

(75) Inventor: Hiroki Fukushima, Tokyo (JP)

Correspondence Address: MCDERMOTT WILL & EMERY LLP, 600 13TH STREET, N.W., WASHINGTON, DC, 20005-3096, US

(73) Assignee: YAMATAKE CORPORATION, Tokyo (JP)

(21) Appl. No.: 12/817,305

(22) Filed: Jun. 17, 2010

(30) Foreign Application Priority Data
Jun. 18, 2009 (JP) 2009-145411

(51) Int. Cl. G05B 11/01

(52) U.S. Cl. 700/14

(57) ABSTRACT

A facilities control device includes control point acquiring means for acquiring control point data for monitoring and controlling the operation of the facilities equipment; monitoring interval setting means for setting monitoring intervals depending on the types of the control point data; control point data monitoring means for comparing the previous-cycle value and the present-cycle value of control point data to monitor whether or not there has been a change within the monitoring interval; and monitoring result notifying means for providing notification in the event that that there is a determination that there has been no change in control point data within the monitoring interval.

### CROSS REFERENCE TO RELATED APPLICATIONS

The present application claims priority under 35 U.S.C. §119 to Japanese Patent Application No. 2009-145411, filed Jun. 18, 2009, which is incorporated herein by reference.

### FIELD OF TECHNOLOGY

The present invention relates to a facilities control device and a facilities control method for detecting a non-changing status of facilities equipment.

### BACKGROUND OF THE INVENTION

In facilities control devices for plants, construction equipment, and the like, there are a vast number (ranging from 1000 points to several tens of thousands of points) of control point data such as equipment operating/stopped statuses, warning information, set values that are read/written, measurement information from detectors (sensors, cameras, and the like). Facilities control devices monitor changes in each of the control point data in real-time, to provide notification of status change information (from running to stopped, from stopped to running, or the like), issued warning information, measurement of value change information, and the like. (See, for example, Japanese Unexamined Patent Application Publication 2006-352644 and Japanese Unexamined Patent Application Publication the H9-331362).

Because conventional facilities control devices are structured as set forth above, control points that have changed can be detected, notification thereof can be provided, and they can be monitored thereafter; however, the exact opposite is true for control points that do not change, where there is a problem in that there is no check function, and it is not possible to confirm whether or not the control point data appears to be correct.

The present invention is to resolve the problem area set forth above, and the object thereof is to provide a facilities control device and facilities control method capable of evoking the attention of an operator to cause an awareness of the importance of maintenance by monitoring control point data and providing a notification when there is no change over a predetermined time interval.

### SUMMARY OF THE INVENTION

The facilities control device according to the present invention includes control point data acquiring means for acquiring, at predetermined intervals, control point data for monitoring and controlling the operation of equipment; control point data monitoring means for comparing the previous-cycle value and the present-cycle value for the control point data acquired by the control point data acquiring means, and for monitoring whether or not there is a change over a specific monitoring interval; and monitoring result notifying means for providing notification when there is a determination by the control point data monitoring means that there has been no change in control point data within the monitoring interval.

The facilities control device as set forth in the present invention has monitoring interval setting means for setting a monitoring interval for each type of control point data.

In the facilities control device as set forth in the present invention, the monitoring result notifying means displays, on a monitoring screen, information for each equipment, ranked in order by the length of time over which the previous-cycle values and the present-cycle value have matched.

The facilities control method according to the present invention includes a control point data acquiring step for acquiring, at predetermined intervals, control point data for monitoring and controlling the operation of equipment; a control point data monitoring step for comparing the previous-cycle value and the present-cycle value for the control point data acquired in the control point data acquiring step, and for monitoring whether or not there is a change over a specific monitoring interval; and a monitoring result notifying step for providing notification when there is a determination in the control point data monitoring step that there has been no change in control point data within the monitoring interval.

The facilities control method as set forth in the present invention has monitoring interval setting step for setting a monitoring interval for each type of control point data; wherein, in the control point data monitoring step, monitoring is performed as to whether or not there is a change in the monitoring point data within the monitoring interval set in the monitoring interval setting step.

The facilities control step as set forth in the present invention includes a monitoring result displaying step wherein a notification is received from the monitoring result notifying means step, and information for each equipment is displayed on a monitoring screen, ranked in order by the length of time over which the previous-cycle values and the present value have matched.

Given the present invention, notification is provided if there is no change in control point data, and thus it is possible get a clue about the problem if there is actually a failure in the equipment or machine being controlled using the control point data, or if there is a problem in the data file itself. Doing so makes it possible to compress the time required for investigating cause factors and making diagnoses at the time of maintenance. Furthermore, it is possible to monitor energy use by extracting those equipment and machines that are operating continuously, facilitating the identification of waste. The result is the provision of a facilities control device and facilities control method capable of evoking the attention of the operator to cause an awareness of the importance of maintenance.

The present invention is configured so as to set monitoring intervals for each type of control point data, thus enabling detection to be performed for appropriate non-change intervals for each type of control point data.

The present invention is configured so as to display the information for the various equipment ranked in order by the length of the non-change intervals, enabling data to be extracted and compiled so that, at the time of maintenance, the diagnostics and determination as to whether or not there are problems to be performed rapidly, even when there are vast amounts of data.

### BRIEF DESCRIPTION OF THE DRAWINGS

FIG. 1 is a block diagram illustrating the structure of a facilities control device as set forth in an embodiment according to the present invention.

FIG. 2 is a flowchart illustrating the operation of a facilities control device according to the embodiment.

FIG. 3 is an explanatory diagram for explaining the process in the control point monitoring means of the facilities control device according to the embodiment, wherein FIG. 3 (a) is a time-series graph of digital control point data, FIG. 3 (b) is a time-series graph of analog control point data, and FIG. 3 (c) is a time-series graph of cumulative control point data.

FIG. 4 is an explanatory diagram illustrating one example of a screen display of the facilities control device as set forth in the first form of embodiment.

### DETAILED DESCRIPTION OF THE INVENTION

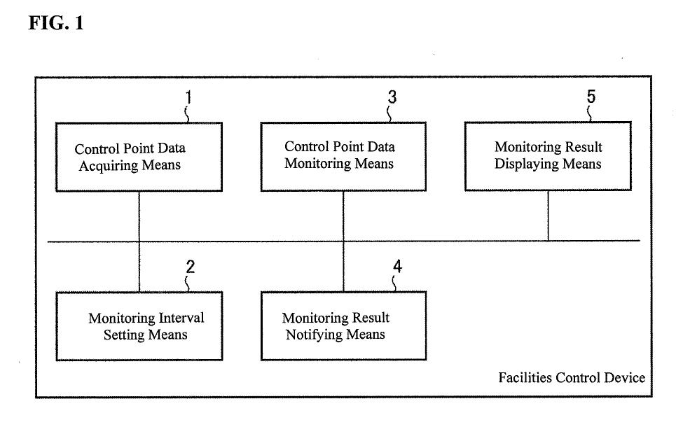

FIG. 1 is a block diagram illustrating the structure of a facilities control device as set forth in an embodiment according to the present invention. The facilities control device illustrated in FIG. 1 includes control point acquiring means 1 for acquiring control point data for monitoring and controlling the operation of the facilities equipment; monitoring interval setting means 2 for setting monitoring intervals depending on the types of the control point data; control point data monitoring means 3 for comparing the previous-cycle value and the present-cycle value of control point data to monitor whether or not there has been a change within the monitoring interval; monitoring result notifying means 4 for providing notification in the event that that there is a determination that there has been no change in control point data within the monitoring interval; and monitoring result displaying means 5 for displaying the information for each equipment, ranked in order of the length of the interval over which the previous cycle value and the present cycle value have been identical for the control point data.

The control point data acquiring means 1 collect, at regular intervals, the control point data that are used for operating and controlling the facilities equipment, to acquire and store in memory, as the present-cycle value, the present value that has been collected, and control this data as control point data.

The monitoring interval setting means 2 set, in advance, monitoring intervals in accordance with the types of control point data (digital data, analog data, cumulative data, etc.). For example, the monitoring interval is set to 48 hours for control point data wherein the operating/stopped state of the equipment or machine is outputted as digital data. Furthermore, the monitoring interval is set to 24 hours for control point data wherein room temperature is outputted as analog data. Moreover, the monitoring interval is set to 72 hours for control point data wherein cumulative data for electric power is outputted.

The control point data monitoring means 3 has a monitoring interval timer, where counting is started when the monitoring interval is started. Given this, the control point data monitoring means 3 compare the previous-cycle values obtained by the control point data acquiring means 1 and the present-cycle values controlled in memory, and reset the counter of the monitoring interval timer if there has been a change, or, otherwise, increment the counter if there has been no change, where if the counter exceeds the monitoring interval, then a no-status-change monitoring result (warning information) indicating that there has been no change in the control point data over the monitoring interval is outputted to the monitoring result notifying means 4.

On the other hand, if the present-cycle value has changed from the previous-cycle value and specific conditions are fulfilled, then the control point data monitoring means 3 may output, to the monitoring result notifying means 4, the monitoring result (status change detection information) that there has been a change in status, indicating that there has been a change in the control point data over the monitoring interval.

Note that the control point data monitoring means 3 may provide notification of the monitoring results to the outside through, for example, a communications circuit.

The monitoring result notifying means 4, upon receipt of the warning information from the control point data monitoring means 3, display, on a display screen provided in the monitoring result displaying means 5, the equipment wherein there has been no change in the control point data during the monitoring interval, doing so as attention-invoking information (a warning). Note that the monitoring result displaying means 5 may be configured through the provision of an audible output function, rather than just a screen displaying function, to provide an audible output, rather than just a screen display, of the attention evoking information. Note that the monitoring result notifying means 4 may provide a screen display to that effect on the monitoring result displaying means 5 even when status change detection information has been received from the control point data monitoring means 3.

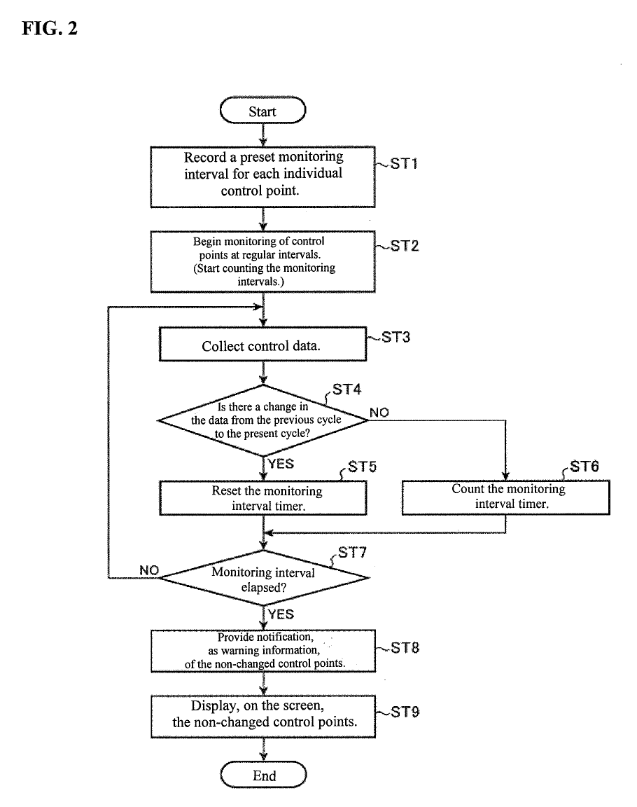

The operation of the facilities control device will be described next. FIG. 2 is a flowchart illustrating the operation of the facilities control device as set forth in the embodiment. First, the monitoring interval setting means reference the information for the monitoring intervals for each type of control point data that have been set in advance, to record the respective monitoring intervals in accordance with the types of the individual control point data collected by the control point data acquiring means 1 (Step ST1, Monitoring Interval Setting Step).

Here as one example, the control point data that is digital data wherein the equipment/machine running is indicated as “1” and stopped is indicated as “0” is defined as the control points #D1 and #D2, where the analog control point data indicating the temperature within the room is defined as control points #A1 and #A2, and the cumulative data control point data for electrical power is defined as control points #I1 and #I2, where these total of six control point data are subject to control. Additionally, monitoring intervals of 48 hours are recorded for the control points #D1 and #D2, monitoring intervals of 24 hours are recorded for the control points #A1 and #A2, and monitoring intervals of 72 hours are recorded for the control points #I1 and #I2, by the monitoring interval setting means 2.

When the monitoring of the control point data for the various equipment is started, the control point data monitoring means 3 start the monitoring interval timers counting, and the control pointer data acquiring means 1 start acquiring data for the various control points (Step ST2). Then the control point data acquiring means 1, at regular intervals, acquire the present-cycle values (Step ST3, Control Point Data Acquiring Step), and the control point data monitoring means 3 compare the present-cycle value and the previous-cycle value (Step ST4).

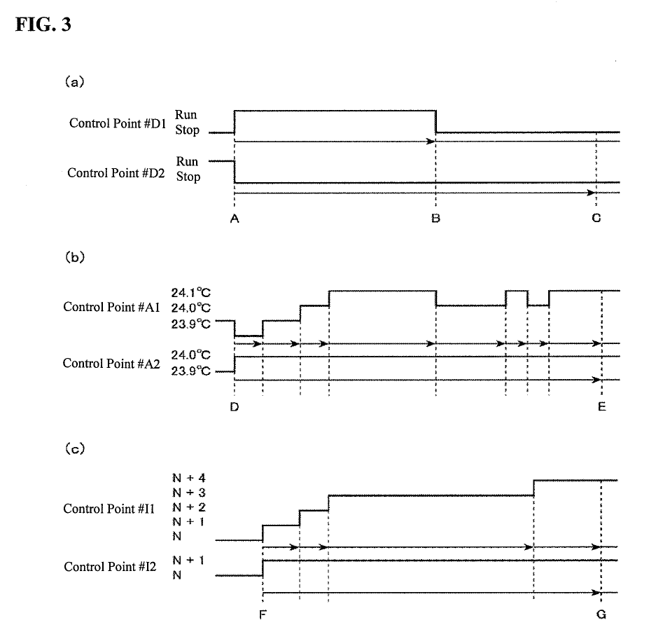

FIG. 3 is a diagram for explaining the processing of the control point data monitoring means 3 in the embodiment, wherein FIG. 3(a) is a time-series graph of the digital data of the control points #D1 and #D2. Note that in FIG. 3, each arrow indicates a counting interval for the monitoring interval timer where the points in time wherein one arrow switches to a new arrow indicate that the monitoring interval timer has been resetted.

At Time A, the present-cycle values of the acquired control points D1 and D2 do not match the previous-cycle values (Step ST4: YES), and the control point data monitoring means 3 resets the monitoring interval timer for the control points #D1 and #D2 (Step ST5). Furthermore, while omitted from the flowchart in FIG. 2, at this time there may be a notification from the control point data monitoring means 3 to the monitoring result notifying means 4, which may be displayed on the screen of the monitoring results displaying means 5. The control point data monitoring means 3 confirm that the count for the monitoring interval timer has exceeded the monitoring interval of 48 hours (Step ST7: NO), and await the acquisition of the control point data for the next regular period.

Because the present-cycle value for the control point #D1 that has been acquired at Time B does not match the previous-cycle value (Step ST4: YES), the control point data monitoring means 3 reset the monitoring interval timer (Step ST5). Additionally, at this time, the control point data monitoring means 3 provide notification to the status change detecting means, which may be displayed on a screen.

The control point data monitoring means 3 confirm that the count of the monitoring interval timer does not exceed the monitoring interval 48 hours (Step ST7: NO), and await the acquisition of control point data in the next cycle.

On top of this, because the present-cycle value for the control point #D2, acquired at Time B matches the previous-cycle value (Step ST4: NO), the control point data monitoring means 3 count the monitoring interval timer (Step ST6). The control point data monitoring means 3 confirm that the count for the monitoring interval timer does not exceed the monitoring interval of 48 hours (Step ST7: NO), and then await the control point data acquired in the next cycle.

The present-cycle values for the monitoring points #D1 and #D2 acquired at Time C match the previous-cycle value (Step ST4: NO), so the respective monitoring interval timers are both incremented (Step ST6). The control point data monitoring means 3 confirm that the monitoring interval timer for the control point #D1 has not exceeded the monitoring interval of 48 hours (Step ST7: NO), and await the control point data acquisition for the next cycle.

On the other hand, because the monitoring interval timer for the control point #D2 exceeds the monitoring interval of 48 hours (Step ST7: YES), the control pointer data monitoring means 3 sends, to the monitoring result notifying means 4, warning data for the control pointer #D2 (Step ST8, Monitoring Result Notification Step). Then the monitoring result notifying means 4 display attention-evoking information based on warning information on the display screen of the warning result displaying means 5 (Step ST 9, Warning Result Display Step). Note that steps ST4 through ST7 control point data monitoring steps.

FIG. 3 (b) is a time-series graph of analog data for the control points #A1 and #A2. The control point data indicating the temperature in the room, that is the control point #A1, has a change in temperature detected by the control point data monitoring means 3, and thus each time a change in temperature is detected, the count for the monitoring interval timer is resetted, and the monitoring interval does not elapse nor is warning information issued. On the other hand, the control point data that indicates the temperature was in the room that is the control point #A2, after the temperature change is detected at Time D, has a value that is uniform, and no change is detected, and thus the counting of the monitoring interval tinier continues without being resetted, and when, at Time E, the 24 hour monitoring interval elapses, warning information is issued from the control point data monitoring means 3.

FIG. 3 (c) is a time-series graph of the cumulative data that is the control points #I1 and #I2. The control point data for the cumulative electric power that is the control point #I1 has changes in the cumulative value detected by the control point data monitoring means 3, and thus each time there is a change in the cumulative value, the count of the monitoring interval timer is resetted, so the monitoring time does not elapse nor is warning information issued. On the other hand, for the control point data for the cumulative electric power that is the control point #I2, after the change in the cumulative value is detected at Time F, the value becomes uniform and no change is detected, and thus the counting of the monitoring interval timer continues without being resetted, and when, at Time G, the monitoring interval of 72 hours elapses, warning information is issued from the control point data monitoring means 3.

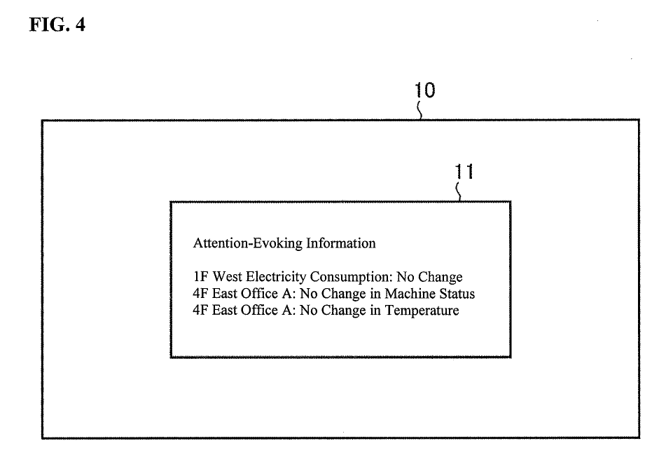

FIG. 4 is an explanatory diagram illustrating one example of a screen display of the monitoring result displaying means 5 in the first form of embodiment. The monitoring results displaying means 5 displays attention-evoking information 11 on a monitoring screen 10. In the present example, attention-evoking information 11 is displayed indicating that there is no status change for the machine of control point #D2 (Fourth Floor East Office, Room A), that there is note temperature change for the control point #A2 (Fourth Floor East Office, Room A), and that there is no change in the cumulative value for the control point #I2 (First Floor West Side Electric Power).

The operator, because of the attention-evoking information 11, becomes aware that some sort of failure has occurred in the equipment/machinery or in the control point data that is the machine status, in-room temperature, and cumulative electric power which actually should be changing, where this failure is due to an imperceptible fault (such as a point contact fault), or a problem with the data file. Additionally, it is possible to identify, from the attention-evoking information 11, those equipment and machines that are constantly running, making it possible to detect wasted energy.

Note that the attention-evoking information 11 may be displayed by ranking the information for the equipment in an order depending on the length of time over which there has been no change. In the example in FIG. 4, the attention-evoking information 11 is displayed in a sequence of the control point #I2 (First Floor West Side Electric Power) wherein the cumulative value has not changed for 72 hours, the control point #D2 (Fourth Floor East Office, Room A) wherein the status has not changed for 48 hours, and the control point #H2 (Fourth Floor East Office, Room A) wherein the temperature has not changed for 24 hours.

Note that if the number of applicable machines is large, then the ranking in the order of the interval over which there has been no change may be displayed for each type of control point data.

As described above, the embodiment includes control point acquiring means 1 for acquiring control point data for monitoring and controlling the operation of the facilities equipment; monitoring interval setting means 2 for setting monitoring intervals depending on the types of the control point data; control point data monitoring means 3 for comparing the previous-cycle value and the present-cycle value of control point data to monitor whether or not there has been a change within the monitoring interval; monitoring result notifying means 4 for providing notification in the event that that there is a determination that there has been no change in control point data within the monitoring interval; and monitoring result displaying means 5 for displaying the information for each equipment, ranked in order of the length of the interval over which the previous cycle value and the present cycle value have been identical for the control point data. Because of this, monitoring the time over which there is no change in each individual data of the equipment control points makes it possible to identify problems, such as imperceptible failures or problems in reading and writing data files, which is useful in tracking down and diagnosing root causes of problems at the time of maintenance, and useful in evaluating the correctness of the data. Furthermore, identifying the equipment that is running continuously, based on the monitoring results of the control point data monitoring means 3 enables the detection and evaluation of wasted energy.

Furthermore, while attention-evoking information 11 was displayed on the monitoring screen 10 by the monitor results displaying means 5 when warning information was issued by the monitoring result notifying means 4, the information for each of the equipment in the attention-evoking information 11 was structured so as to be displayed in rank order based on the length of time over which the previous-cycle values and the present-cycle value have been identical. Because of this, at the time of maintenance it is possible to extract and compile data whereby the facilities and equipment diagnostics and problem evaluation can be performed rapidly, it even if there is a vast amount of data.

1. A facilities control device for monitoring the operation of equipment within a facility, comprising:
a control point data acquiring device acquiring, at predetermined intervals, control point data for monitoring and controlling the operation of equipment;
a control point data monitoring device comparing the previous-cycle value and the present-cycle value for the control point data acquired by the control point data acquiring device, and for monitoring whether or not there is a change over a specific monitoring interval; and
a monitoring result notifying device providing notification when there is a determination by the control point data monitoring device that there has been no change in control point data within the monitoring interval.

2. The facilities control device as set forth in claim 1, further comprising:
a monitoring interval setting device setting a monitoring interval for each type of control point data.

3. The facilities control device as set forth in claim 1, further comprising:
a monitoring result notifying device displaying, on a monitoring screen, information for each equipment, ranked in order by the length of time over which the previous-cycle values and the present-cycle value have matched.

4. A facilities control method for monitoring the operation of equipment within a facility, comprising the steps of:
a control point data acquiring step, acquiring, at predetermined intervals, control point data for monitoring and controlling the operation of equipment;
a control point data monitoring step, comparing the previous-cycle value and the present-cycle value for the control point data acquired in the control point data acquiring step, and for monitoring whether or not there is a change over a specific monitoring interval; and
a monitoring result notifying step, providing notification when there is a determination in the control point data monitoring step that there has been no change in control point data within the monitoring interval.

5. The facilities monitoring device as set forth in claim 4, further comprising the step of:
a monitoring interval setting step, setting a monitoring interval for each type of control point data;
wherein, in the control point data monitoring step, monitoring is performed as to whether or not there is a change in the monitoring point data within the monitoring interval set in the monitoring interval setting step.

6. The facilities monitoring device as set forth in claim 4, further comprising the step of:
a monitoring result displaying step comprising the steps of:
receiving a notification from the monitoring result notifying step, and
displaying information for each equipment on a monitoring screen, ranked in order by the length of time over which the previous-cycle values and the present value have matched.
